(19) United States
(12) Patent Application Publication
(10) Pub. No.: US 2016/0086168 A1
(43) Pub. Date: Mar. 24, 2016

(54) ESTABLISHING COMMUNICATION BETWEEN A READER APPLICATION AND A SMART CARD EMULATOR

(71) Applicant: Microsoft Corporation, Redmond, WA (US)

(72) Inventor: Alex McKelvey, Seattle, WA (US)

(21) Appl. No.: 14/492,944

(22) Filed: Sep. 22, 2014

(51) Int. Cl. G06Q 20/36; G06Q 20/40; G06Q 20/38; G06Q 20/34

(52) U.S. Cl. CPC G06Q 20/367; G06Q 20/341; G06Q 20/405; G06Q 20/401; G06Q 20/3829

(57) ABSTRACT

Disclosed herein are systems and methods implementing a broker component. A broker component receives a request from a reader application executing on the computing device to establish communication with a smart card emulation application. The smart card emulation application is configured to emulate the functionality of a smart card. The broker component, responsive to at least the request from the reader application, determines a particular smart card emulation application and facilitates establishment of communication between the reader application and the particular smart card emulation application.

### BACKGROUND

Typically a “smart card” includes a small integrated circuit (i.e., the “chip”) and a small radio transceiver, usually a near field communication (NFC) transceiver. When placed in contact with, or otherwise brought into proximity with, a smart card reader, the chip inside the card communicates with the reader via NFC. Smart cards can be emulated on a computing device, such as on a mobile phone or tablet computer. An emulator executing on the computing device communicates with a reader using the device's NFC transmitter.

In a typical online transaction, a user types his or her credit card information into a merchant's web site or application. This is an example of a card-not-present transaction, which is more susceptible to fraud than a card-present transaction, since a bad actor need only obtain the credit card number rather than the card itself. Currently there are “wallet” applications that store credit card data on a computing device or in the cloud. These wallet applications automate the input of the credit card information, which is more convenient for the user. Although wallet credit card data can be secured using encryption, transactions using wallet applications are treated as card-not-present transactions.

### BRIEF SUMMARY

This Summary is provided in order to introduce simplified concepts of the present disclosure, which are further described below in the Detailed Description. This summary is not intended to identify essential features of the claimed subject matter, nor is it intended for use in determining the scope of the claimed subject matter.

A broker component establishes communication between a smart card emulation application executing on a computing device and a reader application, which also executes on the computing device. The emulation application emulates an integrated circuit card, chip card, or smart card (collectively referred to herein as smart cards). Broker policies determine a particular emulation application for which to establish communication. The emulation application enforces its own policies in determining whether user authentication or approval is needed, and whether to establish communication with the reader application.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment having a computing device in which a broker component facilitates communication establishment between a reader application and an emulation application.

FIG. 2 illustrates an example environment in which a communication is established between a reader application executing on a first computing device, and an emulation application executing on a second computing device.

FIG. 3A illustrates a reader application user interface screen.

FIG. 3B illustrates a secure user interface screen that prompts a user to select a particular smart card emulation application for use in an online transaction.

FIG. 3C illustrates a secure user interface screen that prompts a user to approve or confirm a transaction.

FIG. 3D illustrates a secure user interface screen that prompts a user to enter a credential.

FIG. 3E illustrates another reader application user interface screen

FIG. 4 depicts a flow diagram of an example process for facilitating, by a broker component, communication between a reader application and an emulation application.

FIG. 5 depicts a flow diagram of an example process for facilitating, by a broker component or a secure processor component, user credential authentication on behalf of an emulation application.

FIG. 6 depicts a flow diagram of an example process for facilitating, by a broker component, obtaining user approval of a transaction.

FIG. 7 depicts a flow diagram of an example process for a smart card emulation application engaging in communication with a reader application.

FIG. 8 depicts a flow diagram of an example process for a smart card emulation application determining whether to approve a transaction and/or establish communications with a reader application.

FIG. 9 depicts a flow diagram of an example process for a reader application to establish communication with a smart card emulation application.

FIG. 10 is a block diagram of an example computing system usable to perform various methods as described herein.

### DETAILED DESCRIPTION

### Overview

Embodiments of the present disclosure establish communication between a smart card emulation application executing on a computing device and a reader application, which also executes on a computing device, which could be the same computing device. The emulation application emulates an integrated circuit card, chip card, or smart card (collectively referred to herein as smart cards). A broker component, such as an Operating System (OS) broker component, facilitates the set-up of the communication between the emulator application and the reader application.

The broker component provides security in conjunction with a secure processor component, such as a Trusted Platform Module (TPM). The secure processor component can store security data such as keys and PINs on behalf of the emulator application and/or the broker component. The secure processor component can perform cryptographic services on behalf of the emulator application, such as validating credentials, encryption, signing a receipt, and so forth. The broker component and/or the secure processor component can present, or cause to be presented, a secure user interface (UI) component that enables the user to select or affirm selection of a card emulation application, enter a credential, approve a transaction, and so forth.

Examples of the present disclosure provide online transactions with improved security. The entity that provides the emulation application is able to trust and vouch for the security of its emulation application. Examples of the present disclosure provide a mechanism by which the entity can verify that its own emulation application is involved with an online transaction with a reader application, in a way that is similar to a physical transaction, thereby enhancing security with respect to the online transaction.

The broker component can execute rules or policies to determine whether to establish communication between the reader application and the smart card emulation application and to determine the emulator application with which to establish the communication. The broker component facilitates communication between the reader application and the smart card emulation application, and enables card-present (or something similar to card-present) transactions.

The devices, processes, and systems described herein can be implemented in a number of ways. Example implementations are provided below with reference to the following figures.

### Example Environment

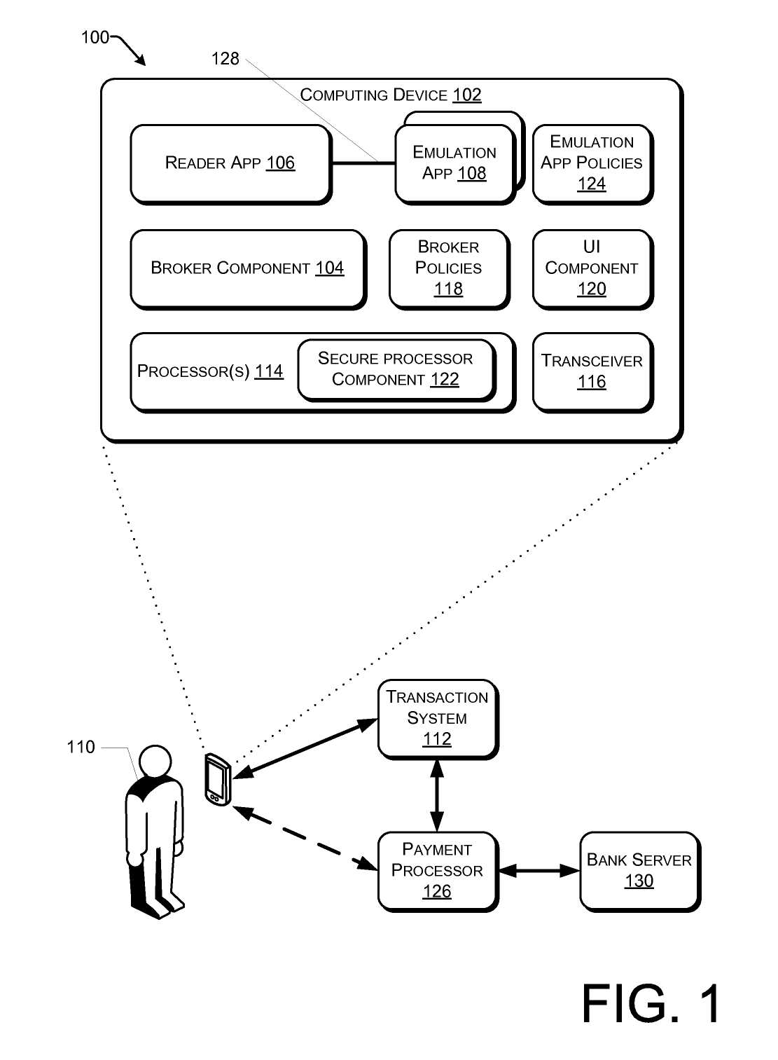

FIG. 1 illustrates an example environment 100 having a computing device 102 in which a broker component 104 facilitates communication establishment between a reader application 106 and an emulation application 108. The reader application 106 provides a user interface that enables a user 110 to engage in an electronic transaction in conjunction with a transaction system 112. The transaction can be, in various examples, a payment card transaction (e.g., a debit card, a credit card, a pre-paid card, or other payment card transaction), a loyalty card transaction (e.g., a store loyalty card transaction, a frequent flyer card transaction, or other), a member card transaction (e.g., a library card transaction, an employee identification card transaction), or other type of transaction. Examples are not limited to any particular type or types of transaction systems 112. The transaction system 112 can be, in various examples, an online e-commerce system that enables the buying and selling of goods and/or services via the Internet. The transaction system 112 can be, in various examples, a government-run system, such as a library website, motor vehicle registration system, tax payment website, or other.

The emulation application 108 emulates functionality of a smart card. A smart card includes a microprocessor and a transceiver, such as an NFC transceiver, and is configured to be powered by radio induction, magnetic induction, or other mechanism when in contact with or in the presence of a smart card reader. A smart card can be a credit card, library card, transit card, security access card, identity card, or other type of card.

Europay MasterCard Visa, or EMV, is one set of standards that define the interaction between a smart card that acts as a credit card and the reader. In an EMV transaction, the reader presents the card with a receipt, which includes information about the transaction such as the identity of the merchant and the purchase amount, and the chip signs the receipt using a symmetric key stored securely inside the chip. A particular non-limiting example of a smart card is an EMV-compliant credit card, e.g., a chip-and-PIN credit card. A smart card can be Smart Card Application Protocol Data Unit (APDU) compliant. The structure of an APDU is established in the ISO/IEC 7816-4 standard promulgated by the International Organization for Standardization (ISO) and the International Electrotechnical Commission (IEC). An EMV-compliant smart card is also compliant with the APDU standard. Many smart cards utilize the APDU standard whether they are EMV-compliant or not.

The emulation application 108 executes on one or more processor(s) 114 to emulate smart card functionality. The emulation application 108 is capable in some examples of communicating with a reader device, such as a smart card reader, via a transceiver 116, which can be a NFC transceiver or other type of transceiver. The emulation application 108 enables the computing device 102 to act as a smart card. For example, when placed into proximity with a physical smart card reader, the emulation application 108 communicates with the smart card reader via the transceiver 116, responds to commands as a smart card, and so forth. The emulation application 108 can be one or both of APDU-compliant and EMV-compliant, or compliant with another standard or standards, or it can be configured to communicate utilizing one or more proprietary protocols. A smart card reader communicating with the emulation application 108 via the transceiver 116 can be unable to distinguish the computing device 102 from an actual smart card. In addition, according to examples of the present application, the emulation application 108 is enabled to communicate with the reader application 106 executing on the computing device 102.

The reader application 106 transmits a request to the broker component 104 to establish a communication channel between the reader application 106 and an emulation application 108. The request can be to an application programming interface (API) associated with the broker component 104. The request can include or be accompanied by an indication of one or more types of emulation applications 108 with which the reader application 106 requests to communicate. An applet identifier (AID) or other identifier can identify a type of smart card (e.g., a payment card, loyalty card, and so forth), and can include further specificity, such as Visa®, Mastercard®, or American Express® credit card, one or more particular issuing entities (e.g., libraries, government entities, banks), and so forth. The request can identify a particular smart card emulation application.

The broker component 104, based at least partly on broker policies 118 stored on the computing device 102, determines a particular emulation application 108, for which to establish communication with the reader application 106. The policies are, in some examples, pre-set, such as by the user 110, by default, or based on a group or standard policy. The broker policies 118 indicate, in some instances, that certain emulation applications 108 are selected by default in all cases, or by default based on an identity of the reader application 106, time information (e.g., time of day, time of week, etc.), location (e.g., home location, work location, other location, etc.), and so forth. In some examples, the broker policies 118 indicate that the user is to be prompted to select one of a plurality of emulation applications 108 on the computing device 102, or to verify a selection of a particular emulation application 108. Examples are not limited to any one broker policy or policies.

In some examples, the emulation applications 108 on the computing device 102 register with the broker component 104 through an API, and are configured to listen for communications, including requests, issued by the broker component 104.

The broker component 104 is configured in some examples to cause a user interface (UI) component 120 to be displayed on a display of the computing device 102. In some examples, the UI component 120 is an operating system (OS) component, or a component executing in a secure mode, that cannot be accessed by components executing in user mode on the computing device 102, such as for example the reader application 106 or other components. The UI component 120 is launched based on broker policies 118, based on request from a particular one of the emulation applications 108, or based on other information.

In various examples, the UI component 120 presents options for the user 110 to select a particular emulation application 108 to be used for transacting and communicating with the reader application 106. In some examples, the UI component 120 presents an option to approve a transaction or communication between the reader application 106 and the emulation application 108. In some examples, the UI component 120 presents an option to provide a credential, and so forth.

In various examples, a credential includes one or more of something that the user knows, something that the user 110 possesses, or a user inherence factor. Something that the user 110 knows can include a password, a passcode, a user identifier, a username, a personal identification number (PIN), a gesture, a signature, a spoken phrase, an answer to a challenge question (e.g., mother's maiden name, favorite brand of breakfast cereal), etc. Something that the user possesses can be a hardware token—e.g., a connected token, e.g., a universal serial bus (USB) token, an audio port token, or a contactless token, e.g., a Bluetooth® token, an NFC token (e.g., another smartcard), a magnetic token (e.g., a magnetic stripe card), or other wireless token)—a mobile phone, a subscriber identity module (SIM) installed in the computing device 102, a security key stored on the computing device 102, a one-time pad, a one-time password (which can be sent to the user via email, short message service (SMS), via a separate application, etc.). Things that are inherent to the user include biometric credentials (e.g., voice, fingerprint, eye recognition—such as retinal or iris scanning—face recognition, etc.), or other. The user credentials can be multi-factor; that is, more than one of something that the user knows, something that the users possesses, and an inherency factor.

In some examples, the credential is specific to the user 110 or specific to the computing device 102. In some examples, the credential can be specific to a particular emulation application 108. For example, the emulation application 108 can stipulate that the user enter a PIN or other credential prior to authorizing a transaction. The credential can be stored securely on the computing device, such as in a secure processor component 122 of the at least one processor 114, or in another location. The credential can be specific to the computing device 102, such as an unlock password or gesture, a log-in username/password, and so forth. The credential can be specific to an account of the user 110 that is accessible on multiple devices, such as a cloud-based account, an account of a content management system, file storage system, etc.; the cloud-based account can be either enterprise or consumer-focused. In some examples, the credential is specific to the broker component 104, and thus used for authorizing some or all transactions through the broker component 104 on the computing device 102. In some examples, the credential is specific to the secure processor component 122. Other credentials are used in various examples.

As noted above, the emulation application 108 can specify a credential. For example, where the emulation application 108 emulates a payment card, the user 110 can be required to enter a PIN or other credential associated with a financial account (e.g., a credit account, a bank account, a brokerage account, or other) to be verified by the emulation application 108 and/or the bank that issued the credit card associated with the emulation application 108. In examples of the present disclosure, a credential used to authenticate the user 110 via the UI component 120 or through other means, can be another credential—e.g., a user-specific, device-specific, or broker-specific credential—that is different from a credential associated with the emulation application 108. In such cases, the broker component 104 and/or the secure processor component 122 authenticates the other credential as a proxy for authenticating the emulation application-specific credential. In some examples, emulation application policies 124 are used to determine whether one or more other credentials can be authenticated by the broker component 104 and/or the secure processor component 122 as a proxy for the emulation application credential, or whether the emulation application 108 enforces use of the emulation application credential. The emulation application policies 124 can also include indication whether any communication or transaction with any reader application is permitted, or whether only NFC-based transactions with physical reader applications are permitted.

The emulation application policies 124 include, in examples, an approved list that identifies one or more reader applications with which communications are allowed. The emulation application policies 124 include, in some examples an unapproved list that identifies one or more reader applications with which communications are not allowed. Even where communications are allowed via an approved list, a requirement for user approval can still be indicated by the emulation application policies 124.

The UI component 120 can be, in some examples, provided partly or wholly by the secure processor component 122 of at least one processor 114 of the computing device 102. The secure processor component 122 can be a TPM or other security-enabled processor component. The secure processor component 122 stores keys, user credential information, etc. Such storage can be secured from various forms of unauthorized access, (e.g., stored in a hardened storage, stored encrypted, stored as a hash, etc.). The secure processor component is also configured to perform cryptographic services such as encryption, decryption, cryptographic signature generation, credential verification, and so forth.

The secure processor component 122 authenticates the user credential and provides notification or indication back to the broker component 104 and/or the emulation application 108 that the credential is authenticated. In some examples, the broker component 104 cooperates with the secure processor component 122 to authenticate the user credential provided via the UI component 120.

The broker component 104 sends a request to the emulation application 108 requesting approval of the establishment of the communication with the reader application 106. The request indicates that the communication will be to a reader application, instead of a physical reader, and other information such as the identity of the reader application, whether user 110 approves of the transaction, whether the user is authenticated, and so forth. The request can include or otherwise be accompanied by information regarding the communication channel; although this information can come at a later stage in the process. The emulation application 108, upon approving the establishment of the communication, responds with approval to the broker component 104.

The broker component 104 establishes communication between the reader application 106 and the emulation application 108. Doing so involves providing information regarding a communication channel 128 to the reader application 106. The communication channel 128 information can be the location of a shared memory space—e.g., a pipe—that enables the reader application 106 to communicate with the emulation application 108. Both the reader application 106 and the emulation application 108 are enabled to write to the shared memory space. The communication channel 128 can run through the broker component 104, such as via an API or other mechanism.

In some examples, the broker component 104 can be an operating system (OS) component, a component that runs in secure mode, or a component provided by the secure processor component 122.

The communication between the reader application 106 and the emulation application 108 involves, e.g., providing the emulation application 108 with a receipt that includes transaction details. The emulation application 108 causes the receipt to be signed using a key stored on the computing device 102, and provides the signed receipt to the reader application 106. In examples, the secure processor component 122 stores the key and potentially performs the encryption of the receipt using the symmetric key in order to produce the signed receipt. Storing the key in the secure processor component 122 and performing the receipt signing of the receipt in the secure processor component 122 provides additional security, making it more difficult to obtain the key from the computing device 102, compared with storing the key in memory on the computing device 102.

The reader application 106 provides the signed receipt to the transaction system 112. The transaction system 112 transmits the signed receipt to a payment processor. Where the emulation application 108 emulates a credit card or other payment card, such as an EMV-compliant payment card, the transaction system 112 can forward the signed receipt and other payment details to a bank server 130. The bank server 130 verifies the signature using the key (which is also stored at the bank server 130), such as by decrypting the signature or by encrypting the receipt using the key to verify that the signature matches the receipt. Other cryptographic verification of the signature can be utilized without departing from the scope of examples. Upon verifying the signature, and upon verifying other transaction details, such as the availability of funds in a bank account of the user 110, and in some instances fraud detection checks (which can be performed by the payment processor 126 instead of or in addition to the banker server 130), the bank server 130 transmits a message to the payment processor 126 authorizing or declining the transaction, which then informs the transaction system 112.

The transaction system 112 transmits a message to the reader application 106 indicating that the transaction was completed, authorized, or declined, and the reader application 106 can present a message on a display of the computing device 102 indicating that status of the transaction.

The computing device is illustrated in FIG. 1 as a mobile device, such as a mobile phone, tablet computer, laptop computer, electronic book reader, personal data assistant, media player, or other similar device. The computing device is not limited to mobile devices. The computing device 102 is, in some examples, a stationary device such as a desktop computer, a game console, or other device. In examples, the computing device 102 is embodied in an internet-enabled appliance such as a television set, video player, music system, a refrigerator, a thermostat, etc. The computing device 102 is in some examples, embodied as a wearable device, such as a watch, smart watch, spectacles, goggles, hat, clothing, and so forth. The computing device 102 is in some examples embodied in a vehicle, such as an automobile, motorcycle, train, airplane, and so forth.

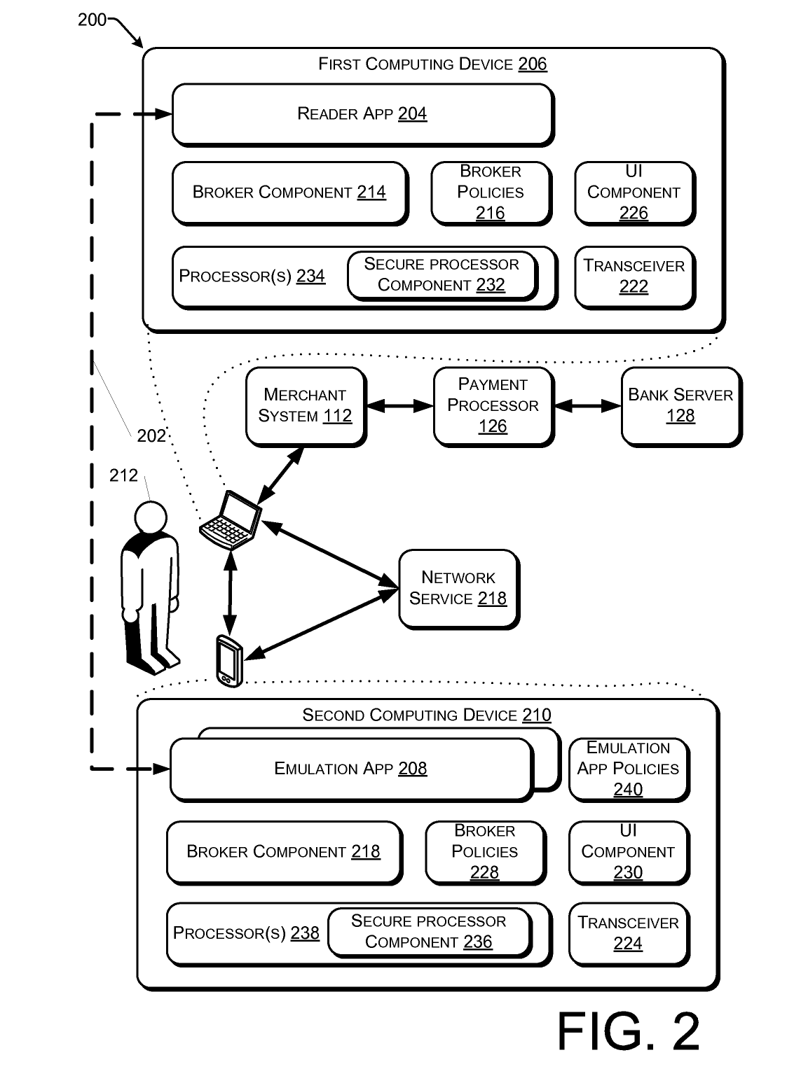

FIG. 2 illustrates an example environment 200 in which a communication 202 is established between a reader application 204 executing on a first computing device 206, and an emulation application 208 executing on a second computing device 210.

The reader application 204 executes on the first computing device 206. The reader application 204 can be the same as or similar to the reader application 106 illustrated in FIG. 1. The reader application 204 provides a user interface that enables a user 212 to engage in a transaction in conjunction with a transaction system, such as the transaction system 112 illustrated in FIG. 1. An emulation application 208 executes on the second computing device 210. The emulation application 208 emulates functionality of a smart card, and can be the same as or similar to the emulation application 108 of FIG. 1.

The reader application 204 transmits a request to a first broker component 214 to establish a communication channel between the reader application 204 and a smart card emulation application. The request can be to an application programming interface (API) associated with the first broker component 214. The request can include or be accompanied by an indication of one or more types of emulators with which the reader application 204 requests to communicate. Where the requested emulation application emulates a smart card, an applet identifier (AID) or other identifier can identify a type of smart card, as described with respect to FIG. 1. The request can identify a particular smart card emulation application.

The first broker component 214 determines where to locate an emulation application, such as based on broker policies 216. In examples, the broker policies 216 can indicate locations of available emulation applications, such as on the first computing device 102, available via another computing device (e.g., the second computing device 210), or via a network service 218. The broker policies 216 indicate which available sources of emulation applications it is permitted to access and/or which it is not permitted to access. The broker policies 216 are, in some examples, pre-set, such as by the user 212, set by default, or set based on a group or standard policy. The broker policies 216 indicate, in some instances, that attempts to connect to an emulation application are to be forwarded to certain sources by default in all cases, or by default based on an identity of the reader application 204, time information (e.g., time of day, time of week, etc.), location (e.g., home location, work location, other location), or other information. In some examples, the broker policies 216 indicate that the user 212 is to be prompted to select one of a plurality of other sources and/or specific emulation applications available on one or more sources, or to verify a selection of a particular computing device or particular emulation application. The broker policies 216 are not limited to any one or broker policy or sets of policies.

Where one or more emulation applications are stored on the first computing device 206, and where broker policies and/or user input indicates to select one of those on-device emulation applications, the first broker component 214 behaves in the same or similar way as the broker component 104 of FIG. 1. Where the broker policies and/or user input indicate to connect to an emulation application on another device, either directly or through the network service, the first broker component 214 attempts to establish such communication as described below.

The first broker component 214, in some examples, transmits a request to the network service 218 for emulation applications. The network service 218, upon authenticating the first broker component 214, the user 212, and/or the first computing device 206, replies with a data indicating one or more of computing device(s) with available or accessible emulation applications, data indicating the emulation applications available on such computing device(s), or other.

The network service 218, in some examples, facilitates a connection between the first computing device 206 and the second computing device 210. The connection can be a direct coupling, such as through Wi-Fi, Bluetooth, near-field communication (NFC), or other. The connection can be indirect, such as through the network service 218. The connection can be via the Internet, or using some other mechanism. The user can be instructed to couple the two devices together, such as using a universal serial bus (USB) cable, to place the devices in proximity to, or in contact with, one another, or to take other action to couple the devices.

In some examples, the network service 218 is not involved in establishing the connection between the first computing device 206 and the second computing device 210. The network service 218, in some examples, provides the identity, network address, or other information to enable the first computing device 206 to connect with the second computing device 210.

The network service 218, in some examples, provides the first broker component 214 with a list of available emulation applications 208 on the second computing device 210, as well as other devices in some examples. In some examples, the network service 218 provides information that the second computing device 210 includes one more emulation applications. In some examples, the network service 218 provides information about other computing devices associated with the user 212, but does not indicate which of those devices include emulation applications or the identities of those emulation applications.

The first broker component 214, in some examples, sends a request to the second broker component 220, such as through a communication link (wired or wireless) with the second computing device 210. In some examples, the first computing device 206 and the second computing device 210 have a pre-established communication, such as through transceivers 222 and 224, respectively. In some examples, the first broker component 214 causes establishment of the communication between the devices upon determining to connect to the second computing device 210 for the purpose of accessing an emulation application (e.g., the emulation application 208). In some examples, discussed above, the network service is involved in establishing communications.

The second broker component 220 receives the request from the first broker component 214 and begins communicating with the first broker component 214. The second broker component 220, in some examples, transmits a list of available emulation applications 208 to the first broker component 214.

The first broker component 214 determines, based at least on broker policies 216, how to proceed, including establishing connection with a particular emulation application on the first computing device 206 and any other computing devices, such as the second computing device 210, by default, or prompting the user, such as via a UI component 226, to choose an emulation application and/or confirm selection of an emulation application. The UI component 226 can prompt the user to confirm selection of the second computing device 210.

The first broker component 214 and/or the second broker component 220, based at least partly on broker policies 216 or broker policies 228, determines a particular emulation application 208, for which to establish communication with the reader application 204. The policies are, in some examples, pre-set, such as by the user 212, by default, or based on a group or standard policy. The broker policies 216 and/or 228 indicate, in some instances, that certain emulation applications 208 are selected by default in all cases, or by default based on an identity of the reader application 204, identify of the first computing device 206, time information (e.g., time of day, time of week, etc.), location (e.g., home location, work location, other location, etc.), and so forth. In some examples, the broker policies 216 and/or 228 indicate that the user 212 is to be prompted to select one of a plurality of emulation applications 208 on the second computing device 210, or to verify a selection of a particular emulation application 208. The broker policies 216 and/or 228 are not limited to these examples.

In some examples, the emulation application 208 on the second computing device 210 registers with the second broker component 220 through an API, and is configured to listen for communications, including requests, issued by the second broker component 220.

The first broker component 214 and/or the second broker component 220 is configured in some examples to cause a user interface (UI) component 226 or 230 to be displayed on a display of the first computing device 206 or the second computing device 210. In some examples, the UI component 226 and the UI component 230 are operating system (OS) components, or a components executing in a secure mode, that cannot be accessed by components executing in user mode on the first computing device 206 or the second computing device 210. The UI component 226 and/or the UI component 230 is launched based on broker policies 216 and/or 228, based on request from a particular one of the emulation applications 208, or based on other information.

In various examples, one of the UI component 226 or the UI component 230 presents options for the user 212 to select a particular emulation application 208 to be used for transacting with the reader application 204. In some examples, one of the UI component 226 or the UI component 230 presents an option to approve a transaction between the reader application 204 and the emulation application 208. In some examples, one of the UI component 226 or the UI component 230 presents an option to provide a credential, and so forth. As described above, a credential includes one or more of a something the user 212 knows, something the user 212 possesses, or a user inherence factor; in addition, multi-factor authentication is used in some examples. The types of credentials utilized in environment 200 are the same as or similar to the credentials described above with respect to environment 100 of FIG. 1. This includes utilizing a first credential as a proxy for an emulation application-specific credential as described above with respect to FIG. 1.

The UI component 226 and the UI component 230, respectively, can be, in some examples, provided partly or wholly by the secure processor component 232 of at least one processor 234 of the first computing system 206, or secure processor component 236 of at least one processor 238 of the second computing device 210. The secure processor component 232 and/or the secure processor component 236 can be a TPM or other security-enabled processor component. The secure processor component 232 and/or the secure processor component 236 stores keys, user credential information, etc. Such storage can be secured from various forms of unauthorized access, (e.g., stored in a hardened storage, stored encrypted, stored as a hash, etc.). The secure processor component 232 and/or the secure processor component 236 are also configured to perform cryptographic services such as encryption, decryption, cryptographic signature generation, credential verification, and so forth.

The broker components 214 and 220 establish communication between the reader application 204 and the emulation application 208, such as via the transceivers 222 and 224. From the user 212 perspective, the second computing device 210, which includes the emulation application 208, can prompt him or her—such as via UI component 230—to confirm selection of the emulation application 208, approve a transaction using the emulation application 208, enter a credential, and so forth, using the second computing device 210. At that point, the user 212 can focus attention back on the first computing device 206 to continue his or her activities thereon.

The communication between the reader application 204 and the emulation application 208 is the same as or similar to the communication described above with reference to FIG. 1, except that it is between two computing devices, rather than purely within a single computing device. Such communication can include the reader application 204 causing a receipt to be transmitted to the emulation application 208, the emulation application 208 causing the receipt to be signed (such as via the secure processor component 236), and the emulation application 208 causing the signed receipt to be transmitted to the reader application 204. In some examples, the emulation application 208 causes the signed receipt to be transmitted directly to the transaction system 112, rather than to the reader application 204. The transaction system 112, the payment processor 126, and the bank server 130 each function in the same or similar way as described above with respect to FIG. 1.

The emulation application policies 240 include, in some examples, a approved list that identifies one or more reader applications, and/or one or more computing devices, with which communications are allowed. The emulation application policies 240 include, in some examples an unapproved list that identifies one or more reader applications, and/or one or more computing devices, with which communications are not allowed.

The first computing device 206 and the second computing device 210 are illustrated in FIG. 2 as mobile devices, but are not so limited. Either or both of the first computing device 206 and the second computing device 210 can be a mobile device, such as a mobile phone, tablet computer, laptop computer, electronic book reader, personal data assistant, media player, or other such device. Either or both of the first computing device 206 and the second computing device 210 are in some examples a stationary device such as a desktop computer, a game console, or other device. In some examples, either or both of the first computing device 206 and the second computing device 210 are embodied in internet-enabled appliances such as a television set, video player, music system, a refrigerator, a thermostat, etc. Either or both of the first computing device 206 and the second computing device 210 are in some examples, embodied as wearable devices, such as a watch, smart watch, spectacles, goggles, hat, clothing, and so forth. Either or both of the first computing device 206 and the second computing device 210 are in some examples embodied in a vehicle, such as an automobile, motorcycle, train, airplane, and so forth.

### Example User Interfaces

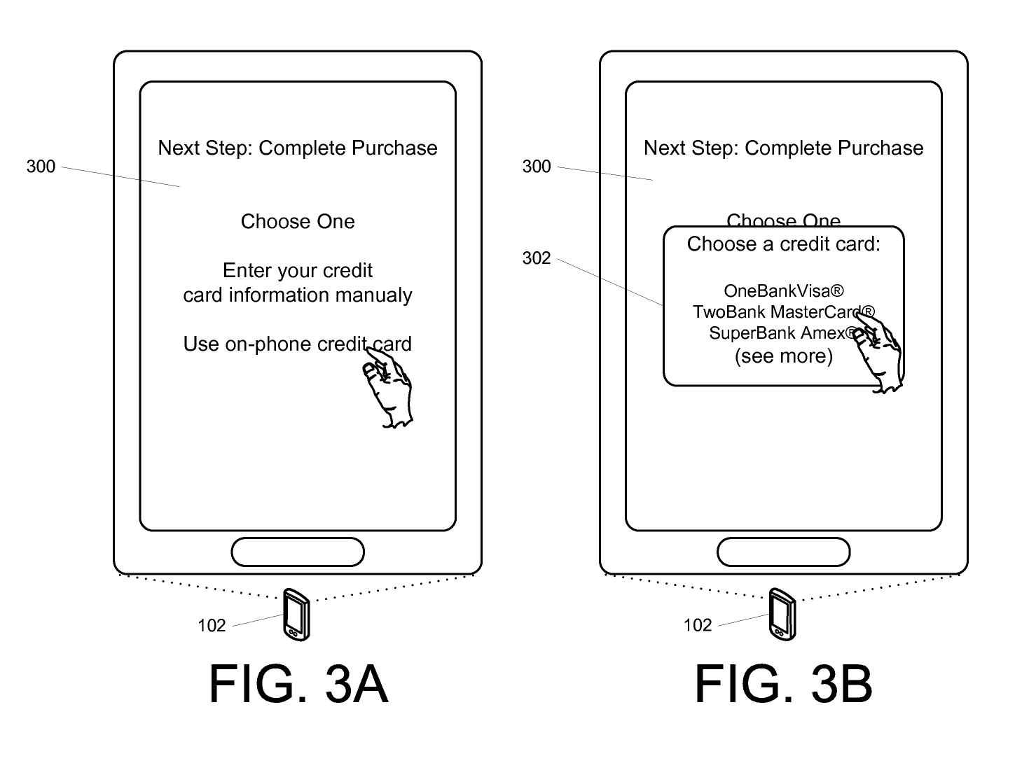

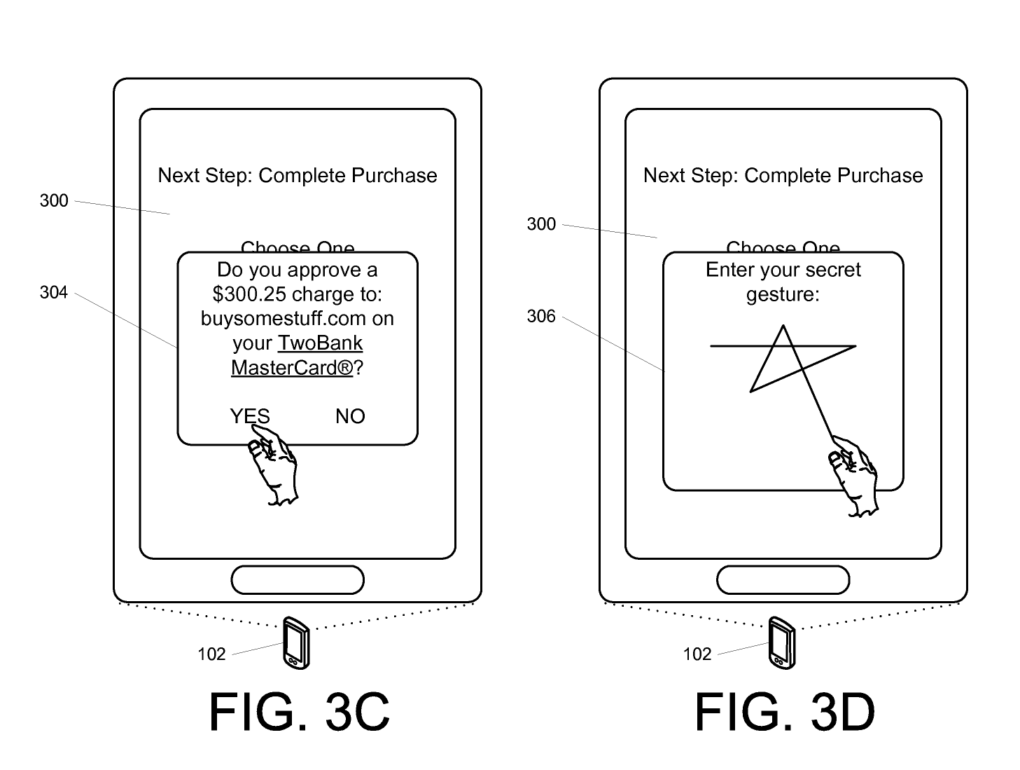

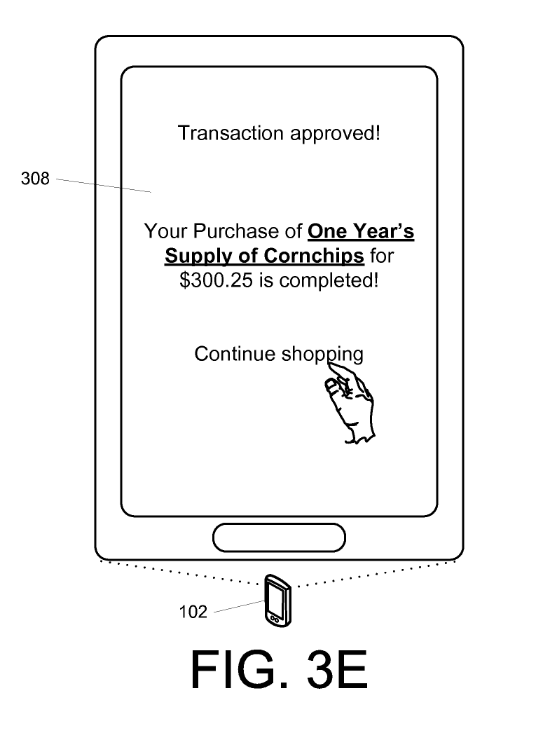

FIGS. 3A-3E depict example user interface screens in accordance with examples. FIG. 3A illustrates a reader application user interface screen 300. In this particular example, the reader application is a merchant application, and during the course of the user interaction with the user interface, the UI prompts the user to select whether to manually enter payment card information, or to use an on-phone credit card. In this example, an on-phone credit card is an emulated smart card credit card, such as can be provided by emulation applications 108 and 208. After receiving data indicating user selection of an emulated smart card, the reader application sends a request to a broker component, such as one of the broker components 104 and 214, to request an emulated smart card.

FIG. 3B illustrates a secure user interface screen 302 that prompts a user to select a particular smart card emulation application for use in an online transaction. In this particular example, the user is requested to choose a particular emulated credit card.

FIG. 3C illustrates a secure user interface screen 304 that prompts a user to approve or confirm a transaction. The example user interface screen 304 includes payment details, such as an amount of a purchase, an identity of the merchant, and a particular emulated credit card that will be used in conjunction with the purchase.

FIG. 3D illustrates a secure user interface screen 306 that prompts a user to enter a credential. The example illustrated in FIG. 3D prompts a user to enter a gesture using a touch-screen interface, but other credentials could be entered in accordance with various examples, as described elsewhere within this Detailed Description.

FIG. 3E illustrates another reader application user interface screen 308. In the example illustrated in FIG. 3E, control of the user interface of the computing device 102 reverts back to the reader application, and informs the user that the transaction has been completed.

Other user interface screens could be used, besides those that are illustrated in FIGS. 3A-E, without departing from the scope of embodiments. For example, other types of smart card transactions, such as security transactions, library check-outs, security access transactions, and so forth can be accomplished using other user interface screens. In some examples, the secure user interface screens 302, 304, and 306 are overlaid on top of user interface screen 300, partially obscuring the user interface screen 300. But in some examples, secure user interface screens can be full-screen or otherwise take over the user interface of the computing device 102.

### Example Processes

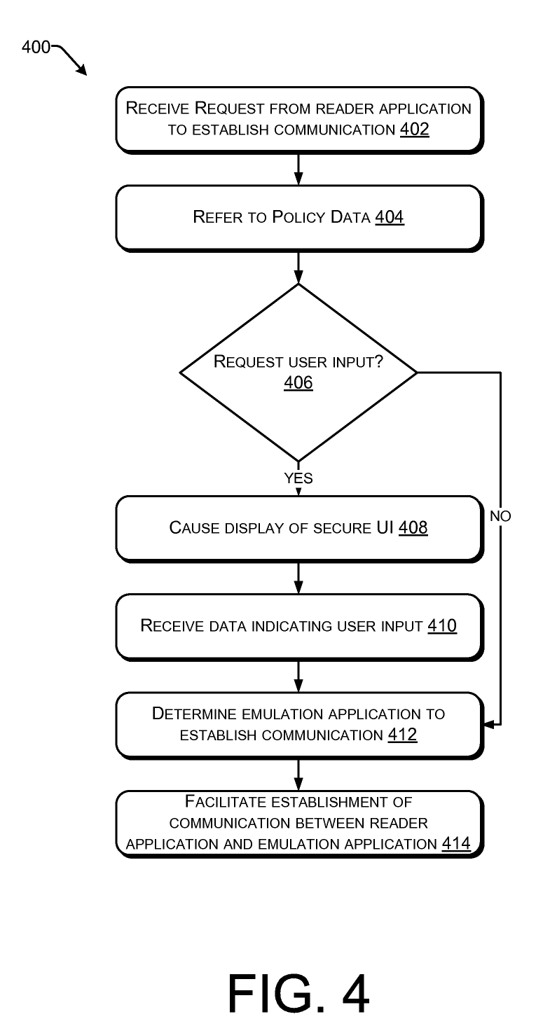

FIG. 4 depicts a flow diagram of an example process 400 for facilitating, by a broker component, communication between a reader application and an emulation application. At 402, a broker component, such as the broker component 104 or 220, receives a request from a reader application to establish communication with a smart card emulation application, such as the emulation application 108 or 208. The smart card emulation application can emulate one of several types of smart cards, such as a loyalty card, a security card, an identity card, a credit card, or other type of smart card. The request from the reader application can indicate a type or types of smart card emulation applications that the reader application requests to communicate with.

At 404, the broker component refers to policy data, such as the broker policies 118 or broker policies 228, in order to determine how to proceed. The policy data includes rules that determine how the broker component responds to the request. The broker policy data can be pre-set, such as by a user, set by default, or set based on group or other policy.

At 406, the broker component determines whether to request user input responsive to the request from the reader application. The broker component can determine whether to request user input by default, or based on the policy data. The broker policy data can indicate that in some instances—such as based on the identities of the reader application and/or the emulation applications, or based on other criteria such as time information, location information, or other information—that the communication is to be established by default, without user intervention or approval. In other instances, the broker component determines that user input is to be requested prior to proceeding.

At 408, the broker component, or a secure processor component (such as the secure processor component 122 or 236), causes display of a secure user interface. The secure user interface, which can be similar to or the same as the user interface screen 302, is interactive to enable selection of one or more of a plurality of smart card emulation applications present on the computing device. In some examples, only one smart card emulation application option is presented to the user. The identities of the smart card emulation applications presented to the user can be based at least on one or more of the broker policies stored on the computing device, a type of smart card emulation application requested by the reader application, and so forth. There can be multiple smart card emulation applications on the computing device, but only a subset can be permitted to communicate with the reader application, and only a subset can match a type requested by the reader application. Thus, less than all of the emulation applications present on the computing device can be presented as options for the user via the secure user interface screen. Information display on the user interface screen is kept secure from other applications or services executing on the computing device including, for example, the reader application itself.

As noted above, the secure user interface can be presented by the broker component, or it can be caused to be presented by a secure processor component of the computing device, such as the secure processor component 122 or secure processor component 236.

At 410, the broker component receives data indicating user input via the secure user interface screen. The user input includes a selection or confirmation of a particular smart card emulation application on the computing device.

At 412, the broker component determines a particular smart card emulation application on the computing device, or another computing device, with which to establish communication. In examples, the determining the particular smart card emulation application includes receiving data indicating selection of the particular smart card emulation application via the user interface. In some examples, the determining is based at least on information stored on the computing device. In some examples, the determining is based on a type of smart card requested by the reader application. In some examples, the determining is based on broker policies, which can identify certain pairings of reader applications, and emulation applications that are allowed and others that are restricted, and so forth. In some examples, a list of other computing devices and/or a list of emulation applications on such other computing devices, can be received from a network service, such as the network service 218. The policies, as noted above, can indicate that certain reader application and emulation application pairings are to be approved or selected by a user. Other policies can be used without departing from the scope of embodiments.

At 414, the broker component facilitates establishment of communication between the reader application and the particular smart card emulation application. Facilitating the establishment of communication by the broker component includes, in various examples, establishing a communication channel for the communications, providing information to the reader application and/or the emulation application regarding the communication channel, indicating to the reader application and the emulation application that the communication channel is approved and set up. The communication channel is, in some examples, a pipe, or a shared memory location (e.g., a pipe) that the reader application and the emulation application are enabled to read and write from. Other communication channels are also possible without departing from the scope of embodiments. For example, the communication channel could be provided via one or more application programming interfaces (APIs) that are provided by the broker component. In some examples, the communication channel can be between computing devices, such as via a wired or wireless connection between the computing devices.

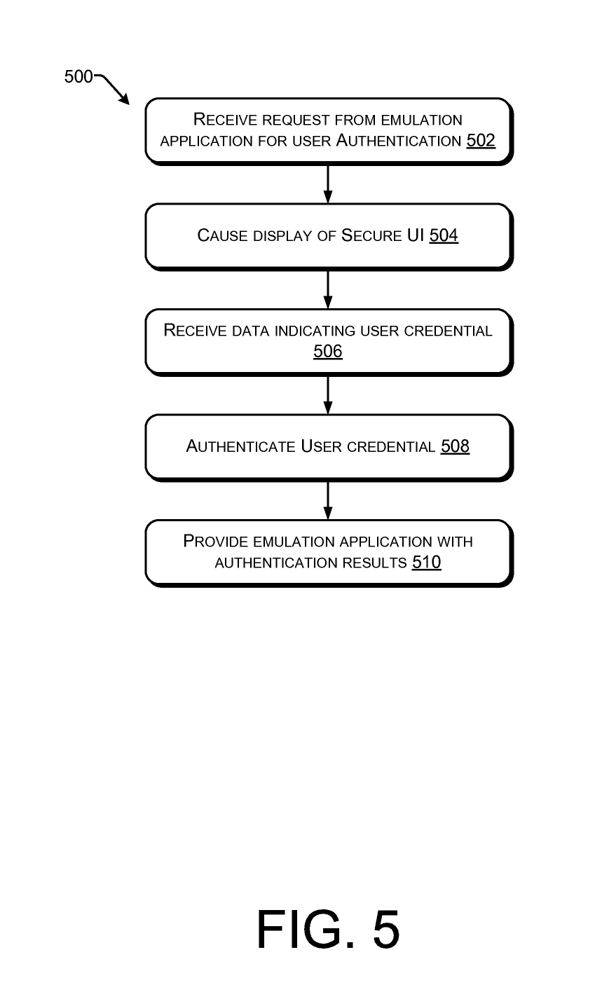

FIG. 5 depicts a flow diagram of an example process 500 for facilitating, by a broker component or a secure processor component, user credential authentication on behalf of an emulation application. At 502, the broker component, or a secure processor component, receives a request from the emulation application to authenticate a user. In some examples, the broker component determines from broker policies, rather than based on a request, to authenticate the user. For example, the broker policies indicate in one example that user authentication is always called for. In some examples, only a subset of transactions call for user authentication, such as based on type of the selected smart card emulation application, the identities of the reader application, the identity of the emulation application, a time-of-day, location, or other information. Thus, in some examples, process 500 occurs without first receiving request from the emulation application.

At 504, the broker component or the secure processor component causes display of a secure UI. Where the broker component causes display, it can do so in some examples in conjunction with the secure processor component. The secure UI screen can be the same as or similar to that illustrated in FIG. 3D. The secure UI screen can request that the user enter an authentication credential. The authentication credential can include one or more of something that the user knows, something that the user possesses, or something inherent to the user, as described in more detail elsewhere within this Detailed Description. One or more input devices, such as a camera, scanner, fingerprint scanner, touch input (such as a touch-screen display), a keyboard, number pad, or other input can be utilized to receive input from the user.

At 506, the broker component and/or the secure processor component receive data indicating the user credential, such as may have been entered via a secure UI screen. At 508, the broker component and/or the secure processor component can authenticate the credential. In examples where the secure processor component authenticates the credential, a stored credential, which can be encrypted, hashed, or otherwise obfuscated on the computing device, is compared to the received user input data to determine if a match is made. In some examples, a network-based authentication can be made, such as to an authentication, authorization and accounting (AAA) server, the network service 218, or other cloud-based or network-based authentication service.

At 510, the broker component or the secure processor component provides the emulation application with the authentication results. Providing the authentication results is, in some examples, made responsive to a request (as in 502) to authenticate the user. In some examples, providing the authentication results is made along with the initial request from the broker component to the emulation application to establish a communication with the reader application. As noted elsewhere within this Detailed Description, the credential that is authenticated can be authenticated as a proxy for authenticating a credential—such as a bank PIN—that is associated with the emulation application. Emulation application policy determines whether such proxy credential authentication is accepted. Where proxy authentication is not accepted, the actual emulation application-specific credential can be authenticated by the broker component and/or the secure processor component.

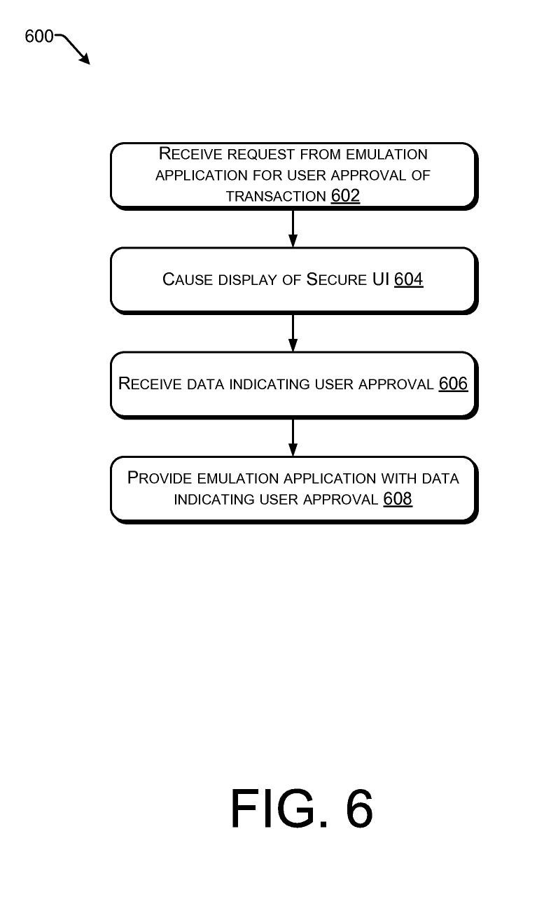

FIG. 6 depicts a flow diagram of an example process 600 for facilitating, by a broker component, obtaining user approval of a transaction. At 602, the broker component receives a request from the emulation application to obtain user approval for the transaction. In one or more alternative embodiments, the broker component determines from broker policies that the user is to be authenticated in one or more instances. For example, the broker policies indicate in one example that user authentication is always called for. In some examples, only a subset of transactions call for user authentication, such as based on type of smart card emulation application, the identities of the reader application, the identities of the emulation application, a time-of-day, location, or other information. Thus, in some examples, process 600 occurs without first receiving request from the emulation application.

At 604, the broker component or the secure processor component causes display of a secure UI. Where the broker component causes display, it can do so in some examples in conjunction with the secure processor component. The secure UI screen can be the same as or similar to that illustrated in FIG. 3C. The secure UI screen provides transaction details, such as an identity of the reader application, identity of the emulation application, an indication of the type of transaction, a purchase amount (where the transaction is a purchase), and so forth. The secure UI screen is interactive to enable the user to approve or deny the transaction.

At 606, the broker component receives data via the secure UI indicating user approval of the transaction. At 608, the broker component provides an indication to the emulation application that the user approves (or does not approve) the transaction. Providing the approval data is, in some examples, made responsive to a request (as in 602) from the emulation application to obtain user approval. In some examples, providing transaction approval data is made along with the initial request from the broker component to the emulation application to establish a communication with the reader application.

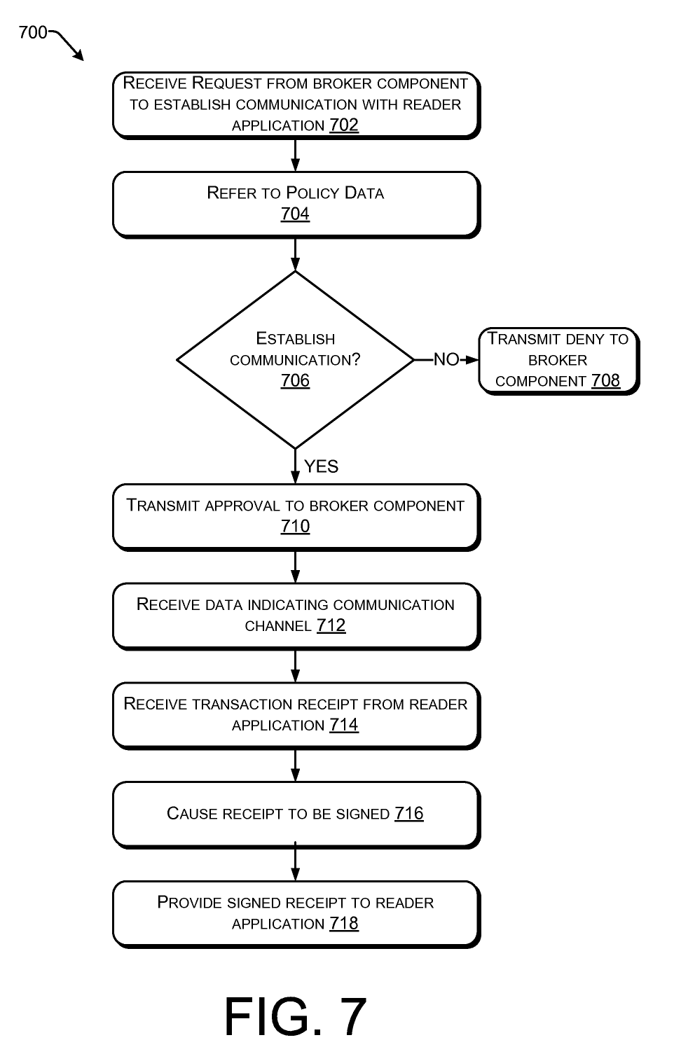

FIG. 7 depicts a flow diagram of an example process 700 for a smart card emulation application engaging in communication with a reader application. At 702, a smart card emulation application receives a request from a broker component, executing on the computing device, to establish a communication channel with a reader application executing on the computing device. The request indicates at least an identity of the reader application. The request can also indicate that a user has been authenticated, that a user has approved the transaction, that the user selected the emulation application, and so forth.

At 704, the emulation application refers to policy data, such as the emulation application policies 124 or the emulation application policies 240. The policy data is consulted in order to determine whether to agree to establish the communication, and what steps are to be taken, if any, prior to agreeing to establish the communication.

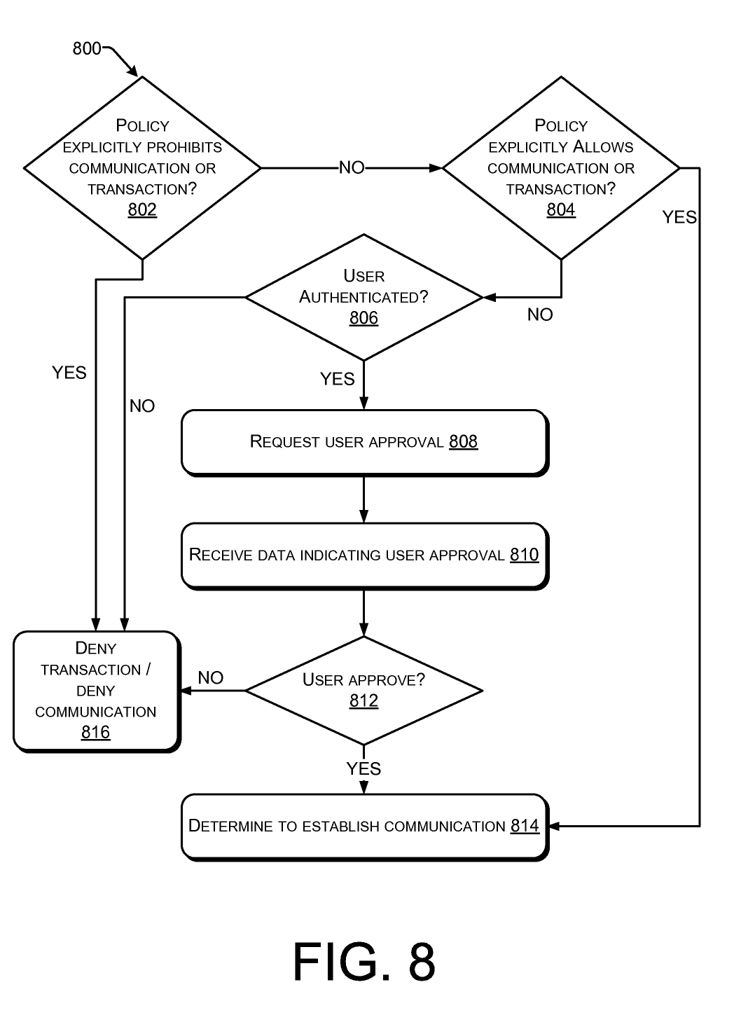

At 706, the emulation application determines, based at least on information stored on the computing device (e.g., the emulation application policy data), whether to approve establishment of the communications channel with the reader application executing on the computing device. Determination of whether to approve the communication channel establishment is based, in some examples, on one or more of user authentication, user approval of the transaction, or other. Further details regarding these processes are included elsewhere within this Detailed Description, including in FIG. 8. In some examples, the emulation application policies include one or more of an approved list that identifies one or more reader applications with which communications are allowed, and an unapproved list that identifies one or more reader applications with which communications are not allowed.

At 708, upon determining that communication is not to be established (the “NO” path), the emulation application transmits a deny communication message to the broker component. At 710, upon determining that communication is to be established (the “YES” path), the emulation application transmits an approval communication message to the broker component.

At 712, the emulation application receives information from the broker component regarding the communication channel that is established to communicate with the reader application. The communication channel can be a shared memory space (e.g., a pipe), an API, or other communication mechanism that enables the emulation application to communicate with the reader application. Receipt of the communication channel information is illustrated in FIG. 7 as being received after approval is transmitted to the broker component at 710. However, the communication channel information can be received at a different time, and can be included in the request received from the broker component to establish communication at 702.

At 714, the emulation application receives, via the communication channel, a transaction receipt from the reader application. The receipt can be a financial transaction receipt, or other type of transaction receipt.

At 716, the emulation application causes the transaction receipt to be signed with a key associated with the smart card emulation application. Causing the transaction receipt to be signed includes encrypting the receipt with the key associated with the smart card emulation application. The key can be stored on a secure processor component, and the secure processor component can provide one or more cryptographic services to the emulation application, including signing the receipt using the stored key. The emulation application provides the transaction receipt to the secure processor component along with a request to sign the transaction receipt the key associated with the smart card emulation application; the secure processor component then provides the signed receipt.

At 718, the emulation application provides, via the communication channel, the signed transaction receipt to the reader application.

FIG. 8 depicts a flow diagram of an example process 800 for a smart card emulation application determining whether to approve a transaction and/or establish communications with a reader application. At 802, the emulation application determines whether its policy explicitly prohibits the transaction or communication. In one example, the emulation application policy includes an unapproved list of reader applications that it is prohibited from transacting with. The unapproved list can be updated periodically to cover known Trojan applications or other malware; the unapproved list can also include reader applications that engage in illegal activity or that are related to entities that it would be illegal to transact with (e.g., entities that are in a country subject to economic sanctions, entities known to sponsor illegal activities, etc.). In some examples, the emulation application policy can explicitly prohibit transactions based on other information, such as time information, location information, user setting, or other. By default, the emulation application can explicitly prohibit all transactions with reader applications until a user-configurable setting is implemented to allow transactions with reader applications. An emulation application can also have a policy prohibiting transactions with all reader applications, and only allowing transactions with physical smart card reader devices.

At 804, upon determining at 802 that the transaction or communication is not explicitly prohibited (the “NO” path), the emulation application determines whether its policy explicitly allows the transaction or communication. A policy can allow all transactions or communications for all reader applications that are not unapproved listed. The policy can include an approved list of reader applications for which transactions and/or communications are automatically allowed (e.g., without user input). The policy can determine that transactions are allowed based on other factors, such as location, time information, user setting, and so forth.

At 806, upon determining at 804 that the policy does not explicitly allow the communication or transaction (the “NO” path), the emulation application determines whether the user is authenticated. Determining whether a user is to be authenticated in order to approve a transaction or communication is based, in some examples, on the emulation application policies; in some examples, it can always be required, while in some examples, requiring user authentication cannot be required at any time. In some examples, user authentication can be required to approve transactions or communication with a subset of reader applications. In some examples, the emulation application requests that the broker component or the secure processor component authenticate the user, as described elsewhere in this Detailed Description. In other examples, an indication that the user has been authenticated by the broker component or the secure processor component can be received with a request from the broker component to establish communications, such as at 702.

At 808, upon determining that the user is authenticated (the “YES”) path, the emulation application requests user approval of the transaction and/or communication. In examples, the emulation application can cause a UI to be displayed on the computing device to the user to approve the transaction and/or communication with the reader application. In some examples, the emulation application can request that the broker component or the secure processor component obtain user approval. The UI can present transaction details, such as the identities of the reader application, identity of the emulation application, a transaction amount, or other details. In some examples, an indication that the user has approved the transaction or communication can be received with a request from the broker component to establish communications, such as at 702.

At 810, the emulation application receives data indicating user approval or denial of the transaction and/or establishment of the communication. At 812, the emulation application determines from the received data whether the user approves or denies the transaction and/or the communication establishment.

At 814, upon determining at 812 that the user approves the transaction and/or the communication, (the “YES” path), the emulation application determines to establish the communication and/or approve the transaction. In some examples, determining to establish communications and/or approve a transaction can be based, in some examples, on one or more of the policies, user authentication, and user approval of the transaction. If any of the policy, user authentication, or user approval is contrary to the establishment of the communication and/or approval of the transaction, the emulation application at 816 denies the transaction and/or the communication establishment.

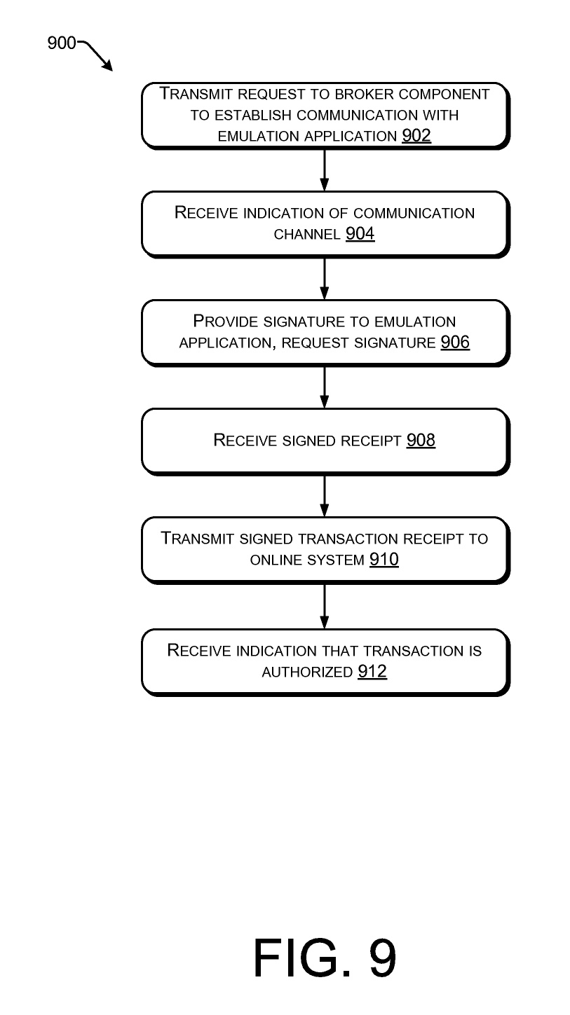

FIG. 9 depicts a flow diagram of an example process 900 for a reader application to establish communication with a smart card emulation application. At 902, a reader application, such as the reader application 106 or 204 transmits, to a broker component, a request to establish communication with a smart card emulation application. The smart card emulation application can execute on the same or different computing device as the reader application. The request can include or be accompanied by information regarding the reader application, the type of smart card emulation application that is being requested to transact with, and so forth.

At 904, the reader application receives from the broker component an indication of a communication channel established for communication with the smart card emulation application. The communication channel can be a shared memory location, e.g., a pipe, which both the reader application and the emulation application can read from and write to. In examples where the emulation application resides on a different computing device than the one that the reader application resides on, the communication channel is established over some sort of communication hardware, as is described elsewhere within this Detailed Description.

At 906, the reader application transmits to the smart card emulation application a transaction receipt via the communication channel. The transaction receipt includes various details of the transaction, including a purchase amount, an identity of a merchant or other transacting entity associated with the reader application, and so forth.

At 908, the reader application receives via the communication channel from the smart card emulation application a signed version of the transaction receipt. The signed version of the transaction receipt can include a digital signature, which can include cyphertext produced by the emulation application causing the receipt to be encrypted using a key associated with the emulation application.

At 910, the reader application transmits, via a network connection, the signed version of the transaction receipt to a transaction server. And at 912, the reader application receives from the transaction server an indication that the transaction is authorized. The reader application can cause a message to be presented to a user indicating that the transaction is authorized, such as is shown in FIG. 3E.

### Example Computing Device

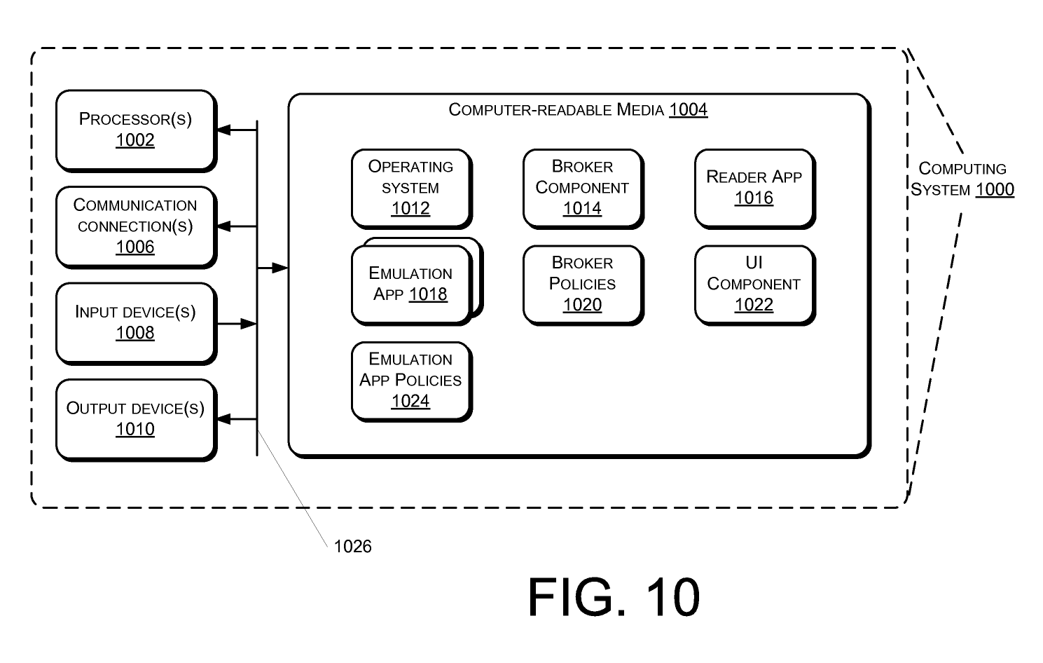

FIG. 10 is a block diagram of an example computing system 1000 usable to perform various methods as described herein. According to various non-limiting examples, the computing system 1000 is a mobile device, such as a mobile phone, tablet computer, laptop computer, electronic book reader, personal data assistant, media player, or other such device. The computing system 1000 is, in some examples, a stationary device such as a desktop computer, a game console, or other device. In some examples, the computing system 1000 is embodied in an internet-enabled appliance such as a television set, video player, music system, a refrigerator, a thermostat, etc. The computing system 1000 is in some examples, embodied as a wearable device, such as a watch, smart watch, spectacles, goggles, hat, clothing, and so forth. The computing system 1000 is in some examples embodied in a vehicle, such as an automobile, motorcycle, train, airplane, and so forth.

In one example configuration, the computing system 1000 comprises at least one processor 1002—which can be the same as or similar to processors 114, 234, and 238. The processors 1002 can include a secure processor component, such as the secure processor components 122, 232, and 236. The computing system comprises computer-readable media 1004. The computing system 1000 can also contain communication connection(s) 1006, such as one of transceivers 116, 222, and 224, as well as other communication hardware, that allow communications with various other systems. The computing system 1000 can also include one or more input devices 1008, such as a keyboard, mouse, pen, voice input device, touch input device, etc., and one or more output devices 1010, such as a display (including a touch-screen display), speakers, printer, etc. coupled communicatively to the processor(s) 1002 and the computer-readable media 1004 via bus 1026.

The computer-readable media 1004 can store computer-executable instructions that are loadable and executable on the processor(s) 1002, as well as data generated during execution of, and/or usable in conjunction with, these programs. In the illustrated example, computer-readable media 1004 stores an operating system 1012, which provides basic system functionality of the computing system 1000 and, among other things, provides for operation of the other programs and modules of the computing system 1000.

The computer-readable media 1004 includes a broker component 1014, which can be the same as or similar to the broker components 104, 214, and 220. The computer-readable media 1004 includes one or more reader applications 1016, which can be the same as or similar to the reader applications 106 and 204. The computer-readable media 1004 includes one or more emulation applications 1018, which can be the same as or similar to one or more of emulation applications 108 and 208. The computer-readable media 1004 includes one or more broker policies 1020, which can be the same as or similar to the broker policies 118, 216, and 228. The computer-readable media 1004 includes one or more UI components 1022, which can be the same as or similar to the UI components 120, 226, and 230. The computer-readable media 1004 includes one or more emulation application policies 1024, which can be the same as or similar to the emulation application policies 124 and 240.

### Computer-Readable Media

Depending on the configuration and type of computing device used, computer-readable media 1004 of the computing system 1000 in FIG. 10 can include volatile memory (such as random access memory (RAM)) and/or non-volatile memory (such as read-only memory (ROM), flash memory, etc.). The computer-readable media 1004 can also include additional removable storage and/or non-removable storage including, but not limited to, SSD (e.g., flash memory), HDD storage or other type of magnetic storage, optical storage, and/or tape storage that can provide non-volatile storage of computer-executable instructions, data structures, program modules, and other data for computing system 1000.

Computer-readable media 1004 can, for example, represent computer memory, which is a form of computer storage media. Computer-readable media includes at least two types of computer-readable media, namely computer storage media and communications media. Computer storage media includes volatile and non-volatile, removable and non-removable media implemented in any process or technology for storage of information such as computer-executable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other medium that can be used to store information for access and retrieval by a computing device. In contrast, communication media can embody computer-executable instructions, data structures, program modules, or other data in a modulated data signal, such as a carrier wave, or other transmission mechanism. As defined herein, computer storage media does not include communication media.

### EXAMPLE CLAUSES

### Example A

A computing system, comprising: at least one processor; memory coupled to the at least one processor; and one or more computer-executable instructions stored on the memory and executable by the at least one processor to implement a broker component that perform acts comprising: receiving a request from a reader application executing on the computing device to establish communication with a smart card emulation application, the smart card emulation application configured to emulate functionality of a smart card; determining responsive to at least the request from the reader application a particular smart card emulation application; and facilitating establishment of communication between the reader application and the particular smart card emulation application.

### Example B

The computing system of example A, wherein the acts further comprise determining the particular smart card emulation application based at least on one or more policies stored on the computing device.

### Example C

The computing system of any of examples A or B, wherein the request includes or is accompanied by an indication of a type of smart card emulation application, and wherein the acts further comprise determining the particular smart card emulation application based at least on the type.

### Example D

The computing system of any of examples A-C, wherein the acts further comprise causing display of a user interface, wherein one or more of: the user interface includes an interactive portion to enable selection of one or more of a plurality of smart card emulation applications present on the computing device, the determining the particular smart card emulation application including receiving data indicating selection of the particular smart card emulation application via the user interface; or the user interface includes an interactive portion to enable confirmation of a transaction associated with the communication between the reader application and the particular smart card emulation application.

### Example E

The computing system of any of examples A-D, wherein the acts further comprise: causing display of a user interface interactive to enable a user to approve a transaction associated with the communication; and providing the smart card emulation application with data indicating user approval of the transaction.

### Example F

The computing system of any of examples A-E, wherein the at least one processor includes a secure processor component of a processor that is configured to provide one or more cryptographic services to the smart card emulation application in association with the communication between the reader application and the smart card emulation application.

### Example G

The computing system of example F, wherein the one or more cryptographic services include signing a receipt provided by the reader application using a key stored on the computing device to produce a signed receipt.

### Example H

The computing system of example F, wherein the one or more cryptographic services include validating a credential entered via a user interface, wherein the credential is one of: a particular credential of the particular smart card emulation application, or a another credential that is validated as a proxy for validating the particular credential of the particular smart card emulation application.

### Example I

The computing system of any of examples A-H, wherein the communication is a Europay MasterCard Visa (EMV) compliant communication in which the smart card emulation application provides at least a cryptographically signed receipt to the reader application as part of a transaction.

### Example J

A method, comprising: receiving a request from a reader application executing on the computing device to establish communication with a smart card emulation application, the smart card emulation application configured to emulate functionality of a smart card; determining responsive to at least the request from the reader application a particular smart card emulation application; and facilitating establishment of communication between the reader application and the particular smart card emulation application.

### Example K

The method of example J, further comprising determining the particular smart card emulation application based at least on one or more policies stored on the computing device.

### Example L

The method of any of examples J or K, wherein the request includes or is accompanied by an indication of a type of smart card emulation application, and wherein the method further comprises determining the particular smart card emulation application based at least on the type.

### Example M

The method of any of examples J-L, further comprising causing display of a user interface, wherein one or more of: the user interface includes an interactive portion to enable selection of one or more of a plurality of smart card emulation applications present on the computing device, the determining the particular smart card emulation application including receiving data indicating selection of the particular smart card emulation application via the user interface; or the user interface includes an interactive portion to enable confirmation of a transaction associated with the communication between the reader application and the particular smart card emulation application.

### Example N

The method of any of examples J-M, further comprising: causing display of a user interface interactive to enable a user to approve a transaction associated with the communication; and providing the smart card emulation application with data indicating user approval of the transaction.

### Example O

The method of any of examples J-N, wherein the at least one processor include a secure processor component of a processor that is configured to provide one or more cryptographic services to the smart card emulation application in association with the communication between the reader application and the smart card emulation application.

### Example P

The method of example O, wherein the one or more cryptographic services include signing a receipt provided by the reader application using a key stored on the computing device to produce a signed receipt.

### Example Q

The method of example O, wherein the one or more cryptographic services include validating a credential entered via a user interface, wherein the credential is one of: a particular credential of the particular smart card emulation application, or a another credential that is validated as a proxy for validating the particular credential of the particular smart card emulation application.

### Example R

The method of any of examples J-Q, wherein the communication includes a Europay MasterCard Visa (EMV) compliant communication in which the smart card emulation application provides at least a cryptographically signed receipt to the reader application as part of a transaction.

### Example S

One or more computer-readable media including a plurality of computer-executable instructions executable by at least one processor of a computing system to cause the computing system to: receive a request from a reader application executing on the computing device to establish communication with a smart card emulation application, the smart card emulation application configured to emulate functionality of a smart card; determine responsive to at least the request from the reader application a particular smart card emulation application; and facilitate establishment of communication between the reader application and the particular smart card emulation application.

### Example T

The one or more computer-readable media of example S, wherein instructions are further executable by the at least one processor to determine the particular smart card emulation application based at least on one or more policies stored on the computing device.

### Example U

The one or more computer-readable media of any of examples S or T, wherein the request includes or is accompanied by an indication of a type of smart card emulation application, and wherein the instructions are further executable by the at least one processor to determine the particular smart card emulation application based at least on the type.

### Example V

The one or more computer-readable media of any of examples S-U, wherein instructions are further executable by the at least one processor to cause display of a user interface, wherein one or more of: the user interface includes an interactive portion to enable selection of one or more of a plurality of smart card emulation applications present on the computing device, the determining the particular smart card emulation application including receiving data indicating selection of the particular smart card emulation application via the user interface; or the user interface includes an interactive portion to enable confirmation of a transaction associated with the communication between the reader application and the particular smart card emulation application.

### Example W

The one or more computer-readable media of any of examples S-V, wherein the instructions are further executable by the at least one processor to cause display of a user interface interactive to enable a user to approve a transaction associated with the communication; and provide the smart card emulation application with data indicating user approval of the transaction.

### Example X

The one or more computer-readable media of any of examples S-W, wherein the at least one processor include a secure processor component of a processor that is configured to provide one or more cryptographic services to the smart card emulation application in association with the communication between the reader application and the smart card emulation application.

### Example Y

The one or more computer-readable media of example X, wherein the one or more cryptographic services include signing a receipt provided by the reader application using a key stored on the computing device to produce a signed receipt.

### Example Z

The one or more computer-readable media of example X, wherein the one or more cryptographic services include validating a credential entered via a user interface, wherein the credential is one of: a particular credential of the particular smart card emulation application, or a another credential that is validated as a proxy for validating the particular credential of the particular smart card emulation application.

### Example AA

The one or more computer-readable media of any of examples S-Z, wherein the communication includes a Europay MasterCard Visa (EMV) compliant communication in which the smart card emulation application provides at least a cryptographically signed receipt to the reader application as part of a transaction.

### Example AB

A computing system, comprising: means for receiving a request from a reader application executing on the computing device to establish communication with a smart card emulation application, the smart card emulation application configured to emulate functionality of a smart card; means for determining responsive to at least the request from the reader application a particular smart card emulation application; and means for facilitating establishment of communication between the reader application and the particular smart card emulation application.

### Example AC

The computing system of example AB, further comprising means for determining the particular smart card emulation application based at least on one or more policies stored on the computing device.

### Example AD

The computing system of any of examples AB or AC, wherein the request includes or is accompanied by an indication of a type of smart card emulation application, and further comprising means for determining the particular smart card emulation application based at least on the type.

### Example AE

The computing system of any of examples AB-AD, further comprising means for causing display of a user interface, wherein one or more of: the user interface includes an interactive portion to enable selection of one or more of a plurality of smart card emulation applications present on the computing device, the determining the particular smart card emulation application including receiving data indicating selection of the particular smart card emulation application via the user interface; or the user interface includes an interactive portion to enable confirmation of a transaction associated with the communication between the reader application and the particular smart card emulation application.

### Example AF

The computing system of any of examples AB-AE, further comprising: means for causing display of a user interface interactive to enable a user to approve a transaction associated with the communication; and means for providing the smart card emulation application with data indicating user approval of the transaction.

### Example AG

The computing system of any of examples AB-AF, further comprising a secure processor component of a processor that is configured to provide one or more cryptographic services to the smart card emulation application in association with the communication between the reader application and the smart card emulation application.

### Example AH

The computing system of example AG, wherein the one or more cryptographic services include signing a receipt provided by the reader application using a key stored on the computing device to produce a signed receipt.

### Example AI

The computing system of example AG, wherein the one or more cryptographic services include validating a credential entered via a user interface, wherein the credential is one of: a particular credential of the particular smart card emulation application, or a another credential that is validated as a proxy for validating the particular credential of the particular smart card emulation application.

### Example AJ

The computing system of any of examples AB-AI, wherein the communication includes a Europay MasterCard Visa (EMV) compliant communication in which the smart card emulation application provides at least a cryptographically signed receipt to the reader application as part of a transaction.

### Example AK

A method comprising: receiving, by the smart card emulation application executing on a computing device, a request from a broker component executing on the computing device to establish a communication channel with a reader application executing on the computing device; based at least on information stored on the computing device, approving establishment of the communications channel with the reader application executing on the computing device; receiving, by the smart card emulation application via the communication channel, a transaction receipt from the reader application; causing the transaction receipt to be signed with a key associated with the smart card emulation application; and providing, by the smart card emulation application via the communication channel, a signed transaction receipt to the reader application.

### Example AL

The method of example AK, further comprising determining, based on the information stored on the computing device, whether to allow the communication channel to be established, the information stored on the computing device including one or more of: a approved list that identifies one or more reader applications with which communications are allowed; or a unapproved list that identifies one or more reader applications with which communications are not allowed.

### Example AM

The method of any of examples AK or AL, wherein the causing the transaction receipt to be signed by a key associated with the smart card emulation application includes: providing the transaction receipt to a secure processor or secure processor component of a processor of the computing device along with a request to sign the transaction receipt the key associated with the smart card emulation application.

### Example AN

The method of any of examples AK-AM, wherein communication between the emulation application and the reader application includes a Europay MasterCard Visa (EMV) compliant communication.

### Example AO

The method of any of examples AK-AN, further comprising: receiving an indication that a user credential is verified, and wherein one or more of approving establishment of the communication channel or causing the transaction receipt to be signed with the key associated with the smart card emulation application is based at least on the indication that the user credential is verified.

### Example AP

The method of example AO, wherein the indication is received from a secure processor component of the computing device.

### Example AQ

A computing system, comprising: at least one processor; memory coupled to the at least one processor; and one or more computer-executable instructions stored on the memory and executable by the at least one processor to perform acts comprising: receiving, by the smart card emulation application executing on a computing device, a request from a broker component executing on the computing device to establish a communication channel with a reader application executing on the computing device; based at least on information stored on the computing device, approving establishment of the communications channel with the reader application executing on the computing device; receiving, by the smart card emulation application via the communication channel, a transaction receipt from the reader application; causing the transaction receipt to be signed with a key associated with the smart card emulation application; and providing, by the smart card emulation application via the communication channel, a signed transaction receipt to the reader application.

### Example AR

The computing system of example AQ, wherein the acts further comprise determining, based on the information stored on the computing device, whether to allow the communication channel to be established, the information stored on the computing device including one or more of: a approved list that identifies one or more reader applications with which communications are allowed; or a unapproved list that identifies one or more reader applications with which communications are not allowed.

### Example AS

The computing system of any of examples AQ-AR, wherein the causing the transaction receipt to be signed by a key associated with the smart card emulation application includes: providing the transaction receipt to a secure processor or secure processor component of a processor of the computing device along with a request to sign the transaction receipt the key associated with the smart card emulation application.

### Example AT

The computing system of any of examples AQ-AS, wherein communication between the emulation application and the reader application includes a Europay MasterCard Visa (EMV) compliant communication.

### Example AU

The computing system of any of examples AK-AT, wherein the acts further comprise: receiving an indication that a user credential is verified, and wherein one or more of approving establishment of the communication channel or causing the transaction receipt to be signed with the key associated with the smart card emulation application is based at least on the indication that the user credential is verified.

### Example AV

The computing system of example AU, wherein the indication is received from a secure processor component of the computing device.

### Example AW

One or more computer-readable media including a plurality of computer-executable instructions executable by at least one processor of a computing system to cause the computing system to: receive, by a smart card emulation application executing on a computing device, a request from a broker component executing on the computing device to establish a communication channel with a reader application executing on the computing device; based at least on information stored on the computing device, approve establishment of the communications channel with the reader application executing on the computing device; receive, by the smart card emulation application via the communication channel, a transaction receipt from the reader application; cause the transaction receipt to be signed with a key associated with the smart card emulation application; and provide, by the smart card emulation application via the communication channel, a signed transaction receipt to the reader application.

### Example AX

The one or more computer-readable media of example AW, wherein the plurality of computer-executable instructions are further executable by the at least one processor of the computing system to cause the computing system to determine, based on the information stored on the computing device, whether to allow the communication channel to be established, the information stored on the computing device including one or more of: a approved list that identifies one or more reader applications with which communications are allowed; or a unapproved list that identifies one or more reader applications with which communications are not allowed.

### Example AY

The one or more computer-readable media of any of examples AW or AX, wherein the causing the transaction receipt to be signed by a key associated with the smart card emulation application includes: providing the transaction receipt to a secure processor or secure processor component of a processor of the computing device along with a request to sign the transaction receipt the key associated with the smart card emulation application.

### Example AZ

The one or more computer-readable media of any of examples AW-AY, wherein communication between the emulation application and the reader application includes a Europay MasterCard Visa (EMV) compliant communication.

### Example BA

The one or more computer-readable media of any of examples AW-AZ, wherein the plurality of computer-executable instructions are further executable by the at least one processor of the computing system to cause the computing system to receive an indication that a user credential is verified, and wherein one or more of approving establishment of the communication channel or causing the transaction receipt to be signed with the key associated with the smart card emulation application is based at least on the indication that the user credential is verified.

### Example BB

The one or more computer-readable media of example BA, wherein the indication is received from a secure processor component of the computing device.

### Example BC

A computing system comprising: means for receiving, by the smart card emulation application executing on a computing device, a request from a broker component executing on the computing device to establish a communication channel with a reader application executing on the computing device; means for approving, based at least on information stored on the computing device, establishment of the communications channel with the reader application executing on the computing device; means for receiving, by the smart card emulation application via the communication channel, a transaction receipt from the reader application; means for causing the transaction receipt to be signed with a key associated with the smart card emulation application; and means for providing, by the smart card emulation application via the communication channel, a signed transaction receipt to the reader application.

### Example BD

The computing system of example BC, further comprising means for determining, based on the information stored on the computing device, whether to allow the communication channel to be established, the information stored on the computing device including one or more of: a approved list that identifies one or more reader applications with which communications are allowed; or a unapproved list that identifies one or more reader applications with which communications are not allowed.

### Example BE

The computing system of any of examples BC or BD, wherein the means for causing the transaction receipt to be signed by a key associated with the smart card emulation application includes: means for providing the transaction receipt to a secure processor or secure processor component of a processor of the computing device along with a request to sign the transaction receipt the key associated with the smart card emulation application.

### Example BF

The computing system of any of examples BC-BE, wherein communication between the emulation application and the reader application includes a Europay MasterCard Visa (EMV) compliant communication.

### Example BG

The computing system of any of examples AK-AN, further comprising: means for receiving an indication that a user credential is verified, and wherein one or more of approving establishment of the communication channel or causing the transaction receipt to be signed with the key associated with the smart card emulation application is based at least on the indication that the user credential is verified.

### Example BH

The computing system of example BG, wherein the indication is received from a secure processor component of the computing device.

### Example BI

One or more computer-readable media including a plurality of computer-executable instructions executable by at least one processor of a computing system to cause the computing system to: transmit, to a broker component executing on the computing system, a request to establish communication with a smart card emulation application that executes on the computing system; receive from the broker component indication of a communication channel established for communication with the smart card emulation application; transmit to the smart card emulation application a transaction receipt via the communication channel; and receive via the communication channel from the smart card emulation application a signed version of the transaction receipt.

### Example BJ

The one or more computer-readable media of example BI, wherein the plurality of computer-executable instructions are further executable by the at least one processor to cause the computing device to: transmit, via a network connection, the signed version of the transaction receipt to a transaction server; and receive from the transaction server an indication that the transaction is authorized.

### Example BK

The one or more computer-readable media of either of examples BI or BJ, wherein the plurality of computer-executable instructions are further executable by the at least one processor to cause the computing device to: provide to the broker component an indication of a type of smart card with which establishment of the communication channel is requested.

### Example BL

The one or more computer-readable media of example BK, wherein the indication of the type of smart card indicates a payment card that is compliant with Europay MasterCard Visa (EMV) standards.

### Example BM

The one or more computer-readable media of example BK, wherein the indication of the type of smart card further indicates that the credit card is associated with a particular credit card transaction entity.

### Example BN

A method comprising transmitting, to a broker component executing on the computing system, a request to establish communication with a smart card emulation application that executes on the computing system; receiving from the broker component indication of a communication channel established for communication with the smart card emulation application; transmitting to the smart card emulation application a transaction receipt via the communication channel; and receiving via the communication channel from the smart card emulation application a signed version of the transaction receipt.

### Example BO

The method of example BN, further comprising transmitting, via a network connection, the signed version of the transaction receipt to a transaction server; and receiving from the transaction server an indication that the transaction is authorized.

### Example BP

The method of either of examples BN or BO, further comprising providing to the broker component an indication of a type of smart card with which establishment of the communication channel is requested.

### Example BQ

The method of example BP, wherein the indication of the type of smart card indicates a payment card that is compliant with Europay MasterCard Visa (EMV) standards.

### Example BR

The method of example BP, wherein the indication of the type of smart card further indicates that the credit card is associated with a particular credit card transaction entity.

### Example BS

A computing system comprising: at least one processor; memory coupled to the at least one processor; and one or more computer-executable instructions stored on the memory and executable by the at least one processor to perform acts comprising: transmitting, to a broker component executing on the computing system, a request to establish communication with a smart card emulation application that executes on the computing system; receiving from the broker component indication of a communication channel established for communication with the smart card emulation application; transmitting to the smart card emulation application a transaction receipt via the communication channel; and receiving via the communication channel from the smart card emulation application a signed version of the transaction receipt.

### Example BT

The computing system of example BS, wherein the acts further comprises transmitting, via a network connection, the signed version of the transaction receipt to a transaction server; and receiving from the transaction server an indication that the transaction is authorized.

### Example BU

The computing system of either of examples BS or BT, wherein the acts further comprise providing to the broker component an indication of a type of smart card with which establishment of the communication channel is requested.

### Example BV

The computing system of example BU, wherein the indication of the type of smart card indicates a payment card that is compliant with Europay MasterCard Visa (EMV) standards.

### Example BW

The computing system of example BU, wherein the indication of the type of smart card further indicates that the credit card is associated with a particular credit card transaction entity.

### Example BX

A computing system comprising: means for transmitting, to a broker component executing on the computing system, a request to establish communication with a smart card emulation application that executes on the computing system; means for receiving from the broker component indication of a communication channel established for communication with the smart card emulation application; means for transmitting to the smart card emulation application a transaction receipt via the communication channel; and means for receiving via the communication channel from the smart card emulation application a signed version of the transaction receipt.

### Example BY

The method of example BX, further comprising means for transmitting, via a network connection, the signed version of the transaction receipt to a transaction server; and receiving from the transaction server an indication that the transaction is authorized.

### Example BZ

The computing system of either of examples BX or BU, further comprising means for providing to the broker component an indication of a type of smart card with which establishment of the communication channel is requested.

### Example CA

The computing system of example BZ, wherein the indication of the type of smart card indicates a payment card that is compliant with Europay MasterCard Visa (EMV) standards.

### Example CB

The computing system of example BZ, wherein the indication of the type of smart card further indicates that the credit card is associated with a particular credit card transaction entity.

### CONCLUSION

Although the techniques have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by at least one processor, enable the at least one processor to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) 102, 206, 210 and/or 1000 such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A computing system, comprising:
at least one processor;
memory coupled to the at least one processor; and
one or more computer-executable instructions stored on the memory and executable by the at least one processor to implement a broker component that perform acts comprising:
receiving a request from a reader application executing on the computing device to establish communication with a smart card emulation application, the smart card emulation application configured to emulate functionality of a smart card;
determining responsive to at least the request from the reader application a particular smart card emulation application; and
facilitating establishment of communication between the reader application and the particular smart card emulation application.

2. The computing system as recited in claim 1, wherein the acts further comprise determining the particular smart card emulation application based at least on one or more policies stored on the computing device.

3. The computing system as recited in claim 1, wherein the request includes or is accompanied by an indication of a type of smart card emulation application, and wherein the acts further comprise determining the particular smart card emulation application based at least on the type.

4. The computing system as recited in claim 1, wherein the acts further comprise causing display of a user interface, wherein at least one of:
the user interface includes an interactive portion to enable selection of one or more of a plurality of smart card emulation applications present on the computing device, the determining the particular smart card emulation application including receiving data indicating selection of the particular smart card emulation application via the user interface; or
the user interface includes an interactive portion to enable confirmation of a transaction associated with the communication between the reader application and the particular smart card emulation application.

5. The computing system as recited in claim 1, wherein the acts further comprise:
causing display of a user interface interactive to enable a user to approve a transaction associated with the communication; and
providing the smart card emulation application with data indicating user approval of the transaction.

6. The computing system as recited in claim 1, wherein the at least one processor include a secure processor component of a processor that is configured to provide one or more cryptographic services to the smart card emulation application in association with the communication between the reader application and the smart card emulation application.

7. The computing system as recited in claim 6, wherein the one or more cryptographic services include signing a receipt provided by the reader application using a key stored on the computing device to produce a signed receipt.

8. The computing system as recited in claim 6, wherein the one or more cryptographic services include validating a credential entered via a user interface, wherein the credential is one of: a particular credential of the particular smart card emulation application, or a another credential that is validated as a proxy for validating the particular credential of the particular smart card emulation application.

9. The computing system as recited in claim 1, wherein the communication includes a Europay MasterCard Visa (EMV) compliant communication in which the smart card emulation application provides at least a cryptographically signed receipt to the reader application as part of a transaction.

10. A method comprising:
receiving, by the smart card emulation application executing on a computing device, a request from a broker component executing on the computing device to establish a communication channel with a reader application executing on the computing device;
based at least on information stored on the computing device, approving establishment of the communications channel with the reader application executing on the computing device;
receiving, by the smart card emulation application via the communication channel, a transaction receipt from the reader application;
causing the transaction receipt to be signed with a key associated with the smart card emulation application; and
providing, by the smart card emulation application via the communication channel, a signed transaction receipt to the reader application.

11. The method as recited in claim 10, further comprising determining, based on the information stored on the computing device, whether to allow the communication channel to be established, the information stored on the computing device including one or more of:
an approved list that identifies one or more reader applications with which communications are allowed; or
an unapproved list that identifies one or more reader applications with which communications are not allowed.

12. The method as recited in claim 10, wherein the causing the transaction receipt to be signed by a key associated with the smart card emulation application includes:
providing the transaction receipt to a secure processor or secure processor component of a processor of the computing device along with a request to sign the transaction receipt using the key associated with the smart card emulation application.

13. The method as recited in claim 10, wherein communication between the emulation application and the reader application includes a Europay MasterCard Visa (EMV) compliant communication.

14. The method as recited in claim 10, further comprising:
receiving an indication that a user credential is verified, and
wherein one or more of approving establishment of the communication channel or causing the transaction receipt to be signed with the key associated with the smart card emulation application is based at least on the indication that the user credential is verified.

15. The method as recited in claim 14, wherein the indication is received from a secure processor component of the computing device.

16. One or more computer-readable media including a plurality of computer-executable instructions executable by at least one processor of a computing system to cause the computing system to:
transmit, to a broker component executing on the computing system, a request to establish communication with a smart card emulation application that executes on the computing system;
receive from the broker component indication of a communication channel established for communication with the smart card emulation application;
transmit to the smart card emulation application a transaction receipt via the communication channel; and
receive via the communication channel from the smart card emulation application a signed version of the transaction receipt.

17. The one or more computer-readable media as recited in claim 16, wherein the plurality of computer-executable instructions are further executable by the at least one processor to cause the computing device to:
transmit, via a network connection, the signed version of the transaction receipt to a transaction server; and
receive from the transaction server an indication that the transaction is authorized.

18. The one or more computer-readable media as recited in claim 16, wherein the plurality of computer-executable instructions are further executable by the at least one processor to cause the computing device to:
provide to the broker component an indication of a type of smart card with which establishment of the communication channel is requested.

19. The one or more computer-readable media as recited in claim 18, wherein the indication of the type of smart card indicates a payment card that is compliant with Europay MasterCard Visa (EMV) standards.

20. The one or more computer-readable media as recited in claim 19, wherein the indication of the type of smart card further indicates that the credit card is associated with a particular credit card transaction entity.
